(19) United States
(12) Patent Application Publication
(10) Pub. No.: US 2022/0304255 A1
(43) Pub. Date: Sep. 29, 2022

(54) WEATHER MANAGEMENT OF CYCLONIC EVENTS

(71) Applicant: Lawrence Sirovich, New York, NY (US)

(72) Inventor: Lawrence Sirovich, New York, NY (US)

(21) Appl. No.: 17/589,775

(22) Filed: Jan. 31, 2022

Related U.S. Application Data
(63) Continuation-in-part of application No. 17/150,931, filed on Jan. 15, 2021, now abandoned.
Application No. 17/150,931 is a continuation-in-part of application No. 16/778,679, filed on Jan. 31, 2020, now abandoned.
Application No. 16/778,679 is a continuation of application No. 13/610,345, filed on Sep. 11, 2012, now Pat. No. 9,078,402.
Application No. 13/610,345 is a continuation-in-part of application No. 11/317,062, filed on Dec. 22, 2005, now Pat. No. 8,262,314.

(51) Int. Cl. A01G 15/00

(52) U.S. Cl. CPC A01G 15/00

(57) ABSTRACT

A method of mitigating the formation of a hurricane comprising the steps of, upon detection of a tropical depression dispatching, to the center of a disturbance, a plurality of vessels modified for stirring and mixing of ocean water. The vessels undertake a cyclonic annular track at the center of the disturbance that will enhance the cooling of the ocean surface layer therefore interfere with hurricane production, and continuing said activity while following said center of said disturbance until the threat of a hurricane is eliminated. A similar method may be used to promote the formation of a hurricane causing said plurality of vessels to undertake an anti-cyclonic circulation annular track to enhance an inflow of warm surface water in order to directly promote hurricane production.

### CROSS-REFERENCE TO RELATED APPLICATION

This application is a continuation-in-part of U.S. application Ser. No. 17/150,931, filed on Jan. 15, 2021 which is related to U.S. patent application Ser. No. 13/610,345 filed on Sep. 11, 2012 issued as U.S. Pat. No. 9,078,402 on Jul. 14, 2015, that was a continuation-in-part (CIP) of U.S. patent application Ser. No. 11/317,062 filed on Dec. 22, 2005 issued as U.S. Pat. No. 8,262,314 on Sep. 11, 2012; and is a continuation-in-part (CIP) of pending U.S. patent application Ser. No. 16/778,679 filed on Jan. 31, 2020, all of which are incorporated as if fully set forth herein.

### BACKGROUND OF THE INVENTION

### 1. Field of the Invention

The present invention generally relates to the field of weather modification and, more specifically, to weather management of cyclonic events.

### 2. Description of the Prior Art

The images of devastation to the Bahamas by hurricane Dorian reveal, in compelling fashion, the economic and human costs of hurricanes. It has been estimated that, in future, economic costs will rise to between $10 billion and $10 trillion dollars per year. Hurricane Katrina, the costliest of US hurricanes, had an estimated cost of $160 billion and claimed 1600 deaths. The deadliest cyclonic even ever was the 1970 Behola cyclone reported to have taken 500,000 lives.

Presently, the best advice for escaping the devastation of hurricanes is to build stronger structures, or to have people hasten to higher ground. It is the intent of this report to shed light on feasible, technologically based solutions to this global problem, which are practical.

A hurricane, at a diameter of a thousand kilometers is huge, and packs the energy of 100,000 medium-sized atomic bombs (Monin,1972) [1]. It is a monster. To attempt controlling such a monster might seem a fool's quest. Yet, it is a fact that a typical hurricane, 10 hours after making landfall, is reduced in intensity by more than a factor of ½, see below, (1).

Two reports “Managing the Risks of Extreme Events and Disasters to Advance Climate Change Adaptation”, Special Report of the Intergovernmental Panel on Climat(1)e Change, 2012) [3] henceforth referred to as Managing (see NYTimes, July 10 editorial, “Heating Up)” [4] and “The Impact of Climate Change on the Hurricane Damages in the United States” (R. Mendelsohn, K. Emanuel, S. Chonabayashi, The World Bank, Finance Economics and Urban Department, Global Facility for Disaster Reduction and Recovery, 2011) [5] henceforth referred to as Impact portend possible dire consequences of climate change. Both reports show the need for a unified long-term program to explore possibilities for diminishing the devastating consequences of tropical cyclone activity. It is the recommendation in this application and applicant's parent application, now issued as U.S. Pat. No. 8,262,314 (“Patent”) [6], that the techniques proposed by applicant provide viable solutions to the prevention of devastating storms and hurricanes. Impact is a wide-ranging comprehensive report based on known statistics and extensive modeling of hurricane activity in the United States. Both Impact & Managing point out that for example a Katrina is an example of a rare event, as are many extreme natural disasters, and therefore one cannot draw convincing predictions from a history of such events. But if climate change is indeed occurring, then increased incidence of such rare events is a compelling consequence.

Intense cyclonic events are global phenomena and in the United States account on average for about $10 billion/year cost in damages (Impact, 2011). In the absence of climate change, and purely on the basis of income and population growth by the year 2100 the forecast is this will rise to between $27 billion/year and $55 billion/year (Impact, 2011).

If climate change predictions are incorporated the yearly destructive costs are expected to lie between $70 billion and $120 billion by the year 2100. Additional effects such as sea level rise have not been factored into these calculations (Impact, 2011).

The world's oceans and seas, as, typically have temperature versus depth profiles that can be characterized generally as shown in FIG. 1 for the Northern hemisphere. For example, the upper layer is usually at a uniform temperature. The temperature is determined by the intensity and duration of solar radiation, as well as the efficiency of wind driven surface driven mixing. Although the depth of the upper layer varies depending on the season, a nominal depth for the upper layer is approximately 20-25 meters. Deeper water is colder than the upper layer. The transition region between upper and lower layers is referred to as the thermocline. The thermocline has a nominal thickness of approximately 20 meters. Although these dimensions vary with time of year and geographic location, the numbers presented are illustrative.

It is well-known that North America hurricanes originate in tropical storms spawned in the tropical waters off the west coast of Africa. It also is understood that the originating tropical storms, and the hurricanes that develop from them, are fueled by the energy content of the warm, upper layers of the ocean. There is correlation between the frequency and strength of such storms and the energy of those upper, warm layers of the ocean. Decreasing the temperature of this upper layer of ocean water diminishes the occurrence and intensity of tropical storms.

U.S. Pat. No. 4,470,544 and U.S. Pat. No. 5,492,274 disclose methods for mixing of sea water to achieve greater rainfall in the Mediterranean basin. Mixing layers of a large body of water increases the potential of solar energy being captured by the water and increases the intensity of storms fueled by the energy content of the seawater. The goal of both these patents is to thicken the upper ˜20 m warm surface layer over the course of months, by the use of surface vessels and devices.

By contrast, U.S. Pat. Nos. 9,078,402 and 8,262,314 are directed at mixing the thermocline with the surface layer, a region —100 m, quickly, less than one day, by submerged devices, which faced no danger by eminent hurricanes and without creating navigational obstructions. The submerged devices, namely submarines, used vertical plates or other bluff surfaces upstream of the stern creating eddy currents and turbulence surrounding the hull.

### SUMMARY OF THE INVENTION

The present invention is for a method of mitigating the formation of a hurricane comprising the steps of

(a) upon detection or the forecast of a tropical depression resulting in predetermined possible cyclonic activity quickly dispatching, to a determined center of a disturbance, a plurality of vessels modified for generating turbulence and stirring of ocean water;

(b) causing said plurality of vessels to undertake a circular, cyclonic band around the origin, which delivers circulation. Due to the Coriolis force, additional cold water is lifted to the surface and directly interfere with hurricane production; and

(c) continuing said cyclonic activity, while following said center of said disturbance until the threat of a hurricane is eliminated.

The invention is also for a method of promoting the formation of a hurricane comprising the steps of

(a) upon detection or the forecast of a tropical depression resulting in predetermined cyclonic activity quickly dispatching, to the center of a disturbance, a plurality of vessels

(b) causing said plurality of vessels to undertake an anti-cyclonic circulation at the center disturbance that will draw in warm surface water to promote hurricane production; and

(c) continuing said activity while following said center of said disturbance until the initiation of the formation of a hurricane is established.

### BRIEF DESCRIPTION OF THE DRAWINGS

The above and other aspects, features and advantages of the present invention will be more apparent from the following description when taken in conjunction with the accompanying drawings, in which:

FIG. 1 is a diagram depicting the water depth of the thermocline for various months of the year in an area of the North Atlantic;

FIG. 2 illustrates, in the left column, the case of the North Atlantic, with upper layer Hu =20 m, and temperature Tu=27° C.; the lower layer Hl=50 m, and at a temperature Tl=20° C., and, in the right column, represents the uniformly mixed upper and lower columns. Both columns are one m² cross-section;

FIG. 3 illustrates examples of three different thermocline locations showing ocean temperature variations as they typically appear for the month of August in the Gulf of Mexico, the Caribbean and the Atlantic Ocean;

FIG. 4 illustrates, as an example, the path or course of the 1988 Hurricane Gilbert as it passed over the Yucatan Peninsula into the Gulf of Mexico before reaching the Mexico mainland;

FIG. 5 illustrates an image of the sea temperature on Sep. 12, 1988 prior to Hurricane Gilbert traversing the trajectory shown in FIG. 4;

FIG. 6 is similar to FIG. 5 but illustrates the sea temperature on September 17, 1998 after Hurricane Gilbert has traversed the trajectory shown in FIG. 4 and made landfall;

FIG. 7 Illustrates streamlines for the inviscid model of a tropical depression, based on a circular region around the origin, corresponding to a radius of 30 miles The streamlines correspond to θ=0° to θ=360°. The streamlines shown above model a tropical depression at a nominal North

Atlantic latitude. More southerly latitudes have more radial streamlines, more northerly latitudes the streamlines show more swirls

FIG. 8 (A) illustrates Mesoscale eddy formation; and

FIG. 8 (B) illustrates eddies cast off the Gulf Stream, like vortices in a von Karman vortex trail.

### DETAILED DESCRIPTION

Gray (1979) [7], summarizes conditions deemed necessary, thermodynamic, and mechanical, in order to generate and sustain a hurricane in the atmosphere. The key condition is that the ocean surface layer must be at least 26° C., in order to provide sufficient latent-heat input to sustain cyclonic activity. Gallacher et al (1989) [8], and Emanuel (1989) [9], indicate that “a 2.5° C. decrease in temperature near the core of the storm (hurricane) would suffice to shut down energy production entirely”. At ocean depths below the surface layer (˜20m) the thermocline begins and leads to a near limitless supply of very cold ocean water. Nominally, the deep cold ocean water is only 0.2% denser than the warm surface layer of ocean. Thus, relatively little work is required to lift the cold water to the surface. A central idea discussed in Applicant's U.S. Pat. No. 8,262,314 is that deep cold ocean water can be used to cool the surface layer along the hurricane path in order to diminish the intensity of an evolving hurricane.

### Introduction

Hurricanes are fueled by inflow of energetic ocean spray, collected at the sea surface, into the low-pressure core of the hurricane eye. This provides energy that escalates the cyclonically upward spiraling of the resulting intense atmospheric vortex. The overall process has been likened to a Carnot cycle (Emanuel 2003; Emanuel 1991). Beyond this, the hurricane ismeteorologically steered dynamically by the ambient atmosphere. A true depiction of hurricanes requires consideration of oceanography and atmospheric interaction, (Pedlosky 2013). The present investigation explores methods which interfere with the fueling role of the ocean, in contrast to the high-profile, meteorological (seeding) attempts for altering hurricanes, of the last century, termed STORMFURY (Willoughby et al. 1985), that were deemed to be a failure.

Any attempt to modify this monster might seem foolhardy. Nevertheless, a hurricane on reaching landfall is removed from its energy source, and undergoes a steady decrease in intensity. Hurricane intensity is measured by maximal hurricane velocity, Vₘ, and modeled by (Kaplan and DeMaria 2001),

$$\frac{d {V}_{m}}{d t} = - \frac{{V}_{m}}{τ} ; τ \approx 10 hr . \qquad ( 1 )$$

Thus, 10 hours after landfall, the strength of a hurricane falls by more than half. It is an empiricalfact that a hurricane cannot form unless the sea surface temperature (SST) is greater than 26° C., (Gray 1979). The possibility of cooling, a portion of its track, in advance of hurricane arrival, will be investigated.

Simply lifting cold ocean water to the surface is inadequate for cooling the surface layer since the prevailing stratification will restore the colder ocean water to its appropriate depth, with negligible mixing. Thorough mixing of the warm surface layer with the deep cool ocean water will be required to produce a new cooler surface layer. Turbulent mixing is the optimal method for achieving the mixing of the warmer surface and cooler thermocline layers.

### Lower Bound on Work for Cyclonic Management

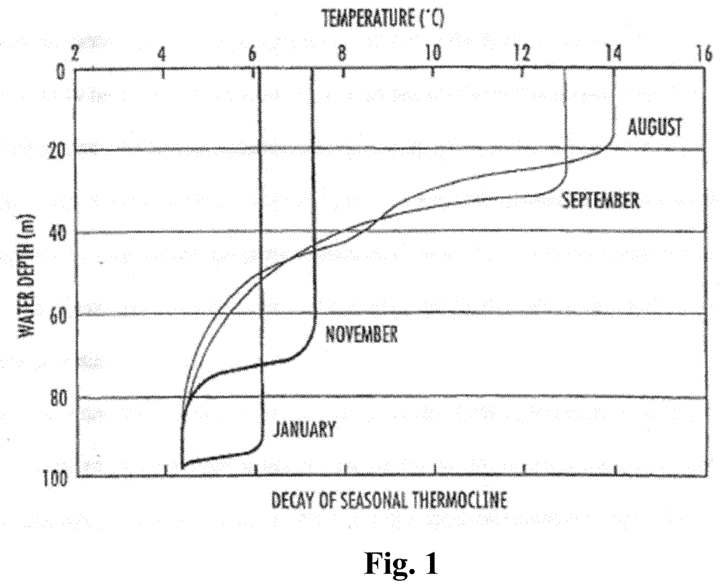

A warm ocean surface layer always lies above a cold deep sea. The transition from the surface layer to the deep cold sea below is referred to as the thermocline (Pedlosky 2013), is depicted in FIG. 1 for the Caribbean, the Gulf of Mexico, and the North Atlantic (NOAA 2009).

A representative calculation will be performed for the North Atlantic hurricane case.

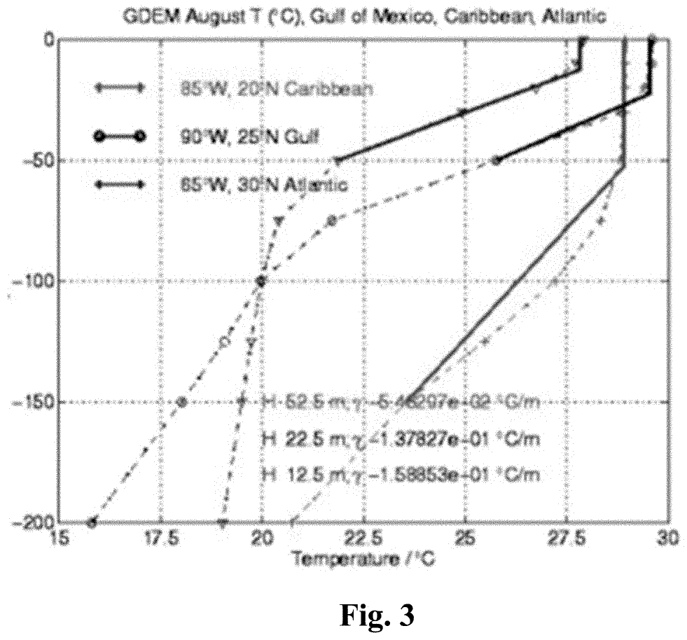

FIG. 3 shows three examples of ocean temperature variations in the Atlantic profile (east of Georgia/Florida).

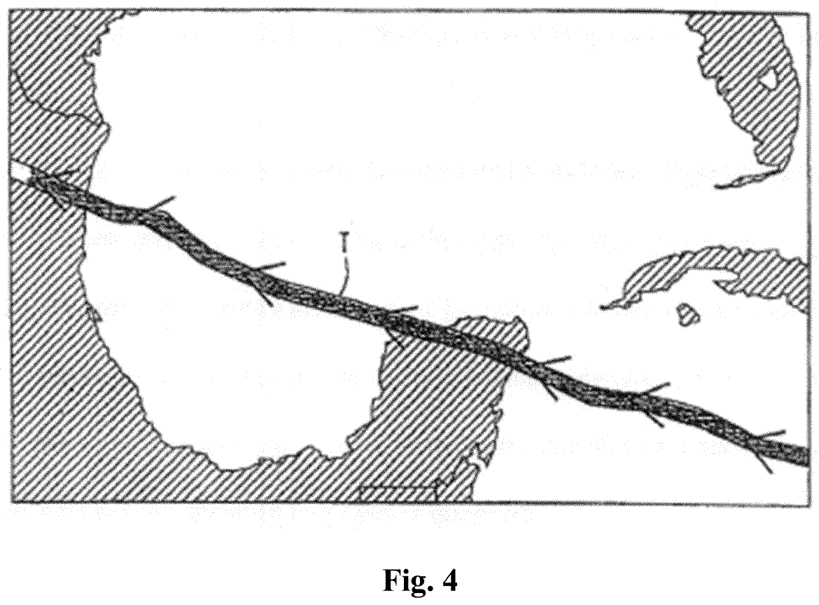

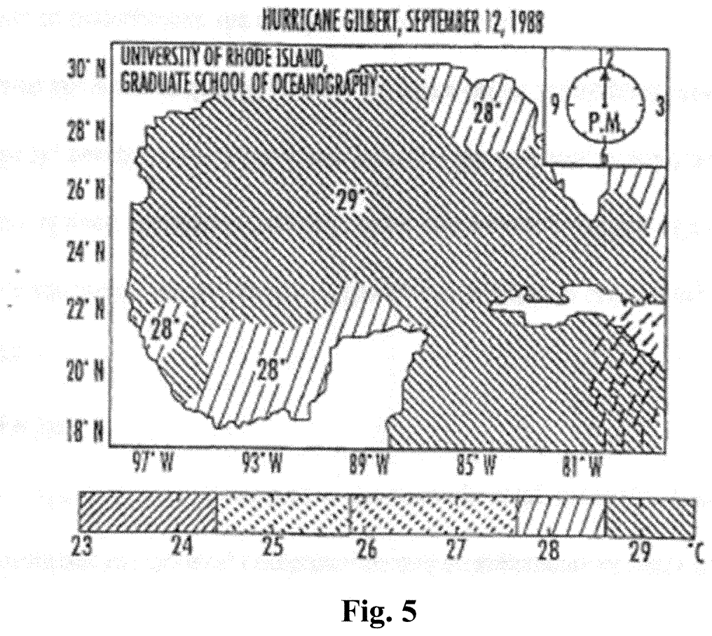

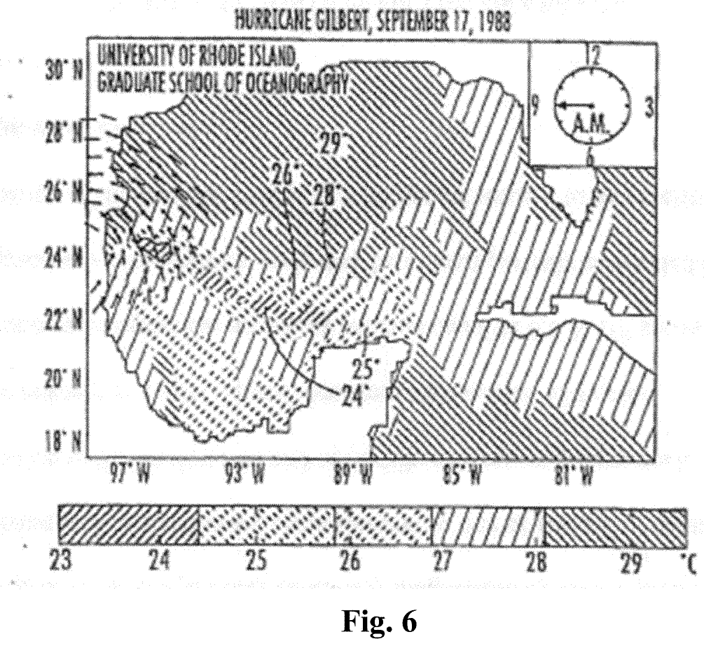

A concern might be whether cooling would persist long enough to be effective. Support for the efficacy of the above mixing approach to ocean cooling comes from sea surface imagery of hurricanes. A consequence of a hurricane passing over an ocean is that it performs the same type of ocean mixing that is proposed to achieve. FIG. 4 illustrates the path or course of the 1998 Hurricane Gilbert, moving from East to West from the Caribbean over the Yucatan Peninsula into the Gulf of Mexico before the landfall over Mexico. In FIG. 5 and FIG. 6 sea surface temperature images are shown acquired for the 1988 hurricane Gilbert as it passed over the Yucatan into the Gulf of Mexico (a full file is obtainable from the University of Rhode Island). Referring to FIG. 5, the sea surface temperatures roughly a day before the track passes over the Yucatan. Thus, on Sep. 12, 1998, the body of water to be traversed by Hurricane Gilbert was approximately 29° C. and some coastal regions approximately 28° C. Referring to FIG. 6, the Sea surface temperatures four days later are shown in FIG. 5, where temperatures along the track of the eye of the hurricane dropped 4-5° C. to 24-25° C. and the water adjoining the track dropped approximately 3° C. to 26° C. The considerable lateral spread, and the persistence of cooling is clear from the imagery. Concern about the temporal persistence of ocean cooling is certainly dispelled. Clearly four days after the passing of the hurricane, the sea surface layer remains well cooled.

The dynamical description of atmospheric hurricanes, (cyclones), is complex, and involves the thermodynamics of wet air, dissipative effects, and a three-dimensional geometry that extends from the ocean surface to the troposphere. This cannot take place without suitable ocean conditions.

There are two essential elements for cyclone initiation: (1) sufficient ocean circulation, originating in the Earth's rotation, and; (2) adequate fueling by a warm ocean surface layer.

Regarding the first of these it should be observed that the earth rotates in counterclockwise manner in the northern hemisphere (clockwise in the southern hemisphere), with rotation rate, S2, given by,

Ω=7.3×10⁻⁵rad·s⁻¹ (2)

where and how this is going to go a seemingly small, but indispensable to a cyclonic event. True local rotation depends on latitude, at the equator there is almost no circulation at the equator, so equatorial cyclones are rare.

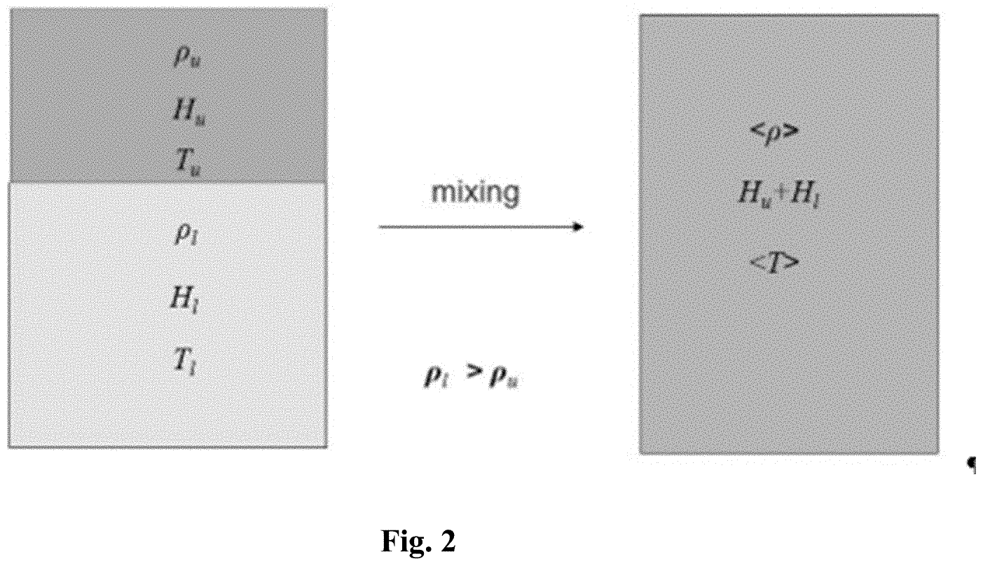

Consider a square meter cross-section column of seawater spanning the surface layer and thermocline, FIG. 2, left. The aim is to mix the column, to obtain the lower temperature uniform column shown at the right. The argument is informal, based on reasonable estimates.

Referring to FIG. 2, for constant heat capacity, the temperature of the mixed state is considered for,

Tᵤ− [symbol] T [symbol] ≈5° C., (3)

a decrease greater than usually needed to reduce the surface layer below 26° C.

The difference in potential energies of the two columns of FIG. 2 represents the absolute minimal needed work, W, to obtain the mixed state,

$$W / {m}^{2} = ( {ρ}_{l} - {ρ}_{u} ) g \frac{{H}_{u} {H}_{l}}{2} , \qquad ( 4 )$$

which for ρ=1027 kg/m³& ρᵤ=1025 kg/m³ yields

W/m²=10⁴ Joules (5)

Emphasis on minimal for (1.4), since it is the absolute lower bound of required work, analogous to the role played by a Carnot cycle in thermodynamics. As will be seen, it is an acceptable ballpark estimate of the true work needed.

To underline the nature of this result, note that (5) is roughly the energy needed to illuminate a200 W bulb for a minute. This calculation, key to further considerations, informs us that since,

ε=(ρₗ−ρᵤ)/ρₗ».2%, (6)

relatively little work is required for mixing. As discussed below an extremely high COP (coefficient of performance) is responsible for this outcome. Also see (Winters et al. 1995).

### Hurricane Mitigation

(Gallacher, Rotunno, and Emanuel 1989) report that “a 2.5° C. decrease in temperature near the core of the storm (hurricane) would suffice to shut down energy production entirely”. Nominal values for hurricane speed and eye diameter are 20 km/h and 50 km., respectively. A reasonable guess for nuclear submarine speed, is ˜67-83 km/h. From these estimates, and hurricane forecasting, it is certain that a submarine pack can intercept and in a timely manner laydown a carpet of cold ocean layer to diminish the intensity of the oncoming cyclones. For example, to create virtual landfall, 10 hours before true landfall, the track area of 50 km×200 km≈10¹⁰ m² by (1.1) would require,

W̅10¹⁴ Joules, (7)

of energy to cool it by 5° C. While the extent of a hurricane might be 1000 km, it is fueled by an ocean area of diameter 50 km, a ratio of 1/20, which will figure in modeling estimates. Since sub speeds are roughly 4 times hurricane speeds, forecast uncertainties become less consequential.

As an example, the Russian Shark class nuclear submarine, has a power rating of ≈2×10⁸ Joules/sec (Naval-Technology.com 2011). This is equivalent to the output of a of a small city power station; thus, a nuclear submarine can be viewed as an ocean going power station. For the 10 hours (=3.6×10⁴ sec.) duration needed to create the virtual landfall, this amounts to a total energy of ≈10¹³Joules. It follows from (7) that 10 submarines might be required to create thevirtual landfall.

### Turbulent Mixing

Cold sea water, raised from the depths, if released at the sea surface, falls back to its natural level, unless quickly mixed, say by turbulence, the most efficient mixer. Based on typical US nuclear submarine specifications (Virginia and Ohio class), a sub's beam is about 40 feet and the speed estimate ˜67-83 km/h. Thus, a typical Reynolds number, Re, is

Re=O(10⁸), (8)

which implies a fully turbulent wake starting with a 14 m stern.

### Hurricanes Costs

Wind forces are proportional to Vₘ², however, hurricane damage is proportional to the rate of work, i.e., power, hence proportional to Vₘ³. This key distinction suggests that if Vₘ are diminished by 20%, costs are halved!

Estimated hurricane costs to world economies can vary from tens of billions to tens of trillionsof dollars, depending on the criteria used in the studies (Kahn 2014; Mendelsohn and Saher 2011). Hence, reducing costs by half takes on profound economic significance.

### Coefficient of Performance

Elementary thermodynamic arguments (Fermi 1956) show that for the nominal 50 km x 200 kmocean area, and a modest depth of 20 meters, to be cooled by 5° C., not by mixing, but by heat removal of a Carnot cycle, requires an energy,

dE≈4×10¹⁸ J. (9)

On the other hand, the above deliberations accomplish this by making use of available deep coldwater, lifted, and mixed with the warm surface water, compared with work, W . This implies that the coefficient of performance is

COP_{cool}=dE/W̅≈10,000. (10)

This is extraordinary compared to a COP of 2 or 3 for a conventional heat pump. At the heart ofthis energy leverage is the slight increase in ocean density with depth, (9).

### Improved Work Estimate

The calculation of W̅, (7), represents is the minimal required work. Elementary dimensional reasoning shows that the true work needed, W_{T}, has the functional form,

$${W}_{T} / \overline{W} = f ( ε , Re ) ) \qquad ( 11 )$$

$$where ,$$

$$ε = \frac{{ρ}_{l} - {ρ}_{u}}{〈 ρ 〉} ( \approx \frac{{T}_{u} - {T}_{l}}{〈 T 〉} ) , \qquad ( 12 )$$

measures the gradient, and Re is the Reynolds Number. It follows from (9) and (11) that (14) should be considered for ε↓0 &Re ↑∞, in which case (14) becomes

W_{T}□ε×W̅, (13)

under a smoothness assumption on f.

A useful guide in these deliberations is the case of a passive scalar, e.g., a dye, in which case full mixingoccurs, in the presence of turbulence, without additional work (Sreenivasan 1991). In view of (2.4), density differences are tiny, and as such are akin to a passive scalar, in which case mixing comes for free. This, and other examples of dimensional reasoning suggests that (13) is unlikely to be off by more than a factor of 2. In the absence of experiment, this is the only support for estimates on the power needed for hurricane management.

### Submarine Modification

Submarine design is influenced by stealth demands, i.e., the need to avoid wake detection bysatellite imaging. The present application is free of this restraint, and on the contrary a large wake is desirable.

It is proposed that the submarine modification include a variable diameter propeller, possibly aslarge as the beam diameter of Do˜40 feet, to enable the action of fully developed turbulence across the wake.

Wake growth, D, with distance downstream, X, is given by D/Do=1.25×(X/Do)^{.22}, an empirical formula (MERRITT 1972) . This predicts that after one sub length, ˜150 m, the wake diameter is ˜33 m. Under this scenario, the work done in lifting the heavier deep oceanwater is subsumed by turbulence.

### Quelling of Tropical Depressions

Tropical depressions are storms of limited extent and strength, that are regarded as hurricane risks, routinely monitored by NOAA. Thus, an alternate strategy might be to dispatch submarinesfrom well-chosen locations, with the mission of removing the potential storm threat. For example, hurricane Dorian, was recognized as a tropical depression, on Aug. 23, 2019; a week later it exhibited cyclonic potential. To explore what might've been done in the intervening week, in simplest terms, involves consideration of vortex motion on a rotating sphere (Newton 2013).

The Euler equations for a frame rotating with angular velocity, are given by,

$$ρ \frac{d \vec{u}}{d t} + ∇ p = ρ ( ∇ \frac{1}{2} \vert \vec{Ω} \times \vec{r} {\vert}^{2} - 2 \vec{Ω} \times \vec{u} ) , \qquad ( 14 )$$

(Kageyama and Hyodo 2006; Pedlosky 2013) where the 2 terms on the right-hand side represent the centripetal and Coriolis accelerations. For the earth's northern is a vector pointing north, can of magnitude

W=7.3′10⁻⁵rad×s⁻¹. (15)

The “Coriolis force” points rightward from the of flow direction u; towards the right bank in thenorthern hemisphere.

To model the surface layer of the ocean, ignore vertical motion and consider the tangent plane z=0. This is given by the polar form of (18),

$$C : \frac{\partial r {u}_{r}}{\partial r} + \frac{\partial {u}_{θ}}{\partial θ} = 0 \qquad ( 16 )$$

$${M}_{r} : \frac{\partial {u}_{r}}{\partial t} + {u}_{r} \frac{\partial {u}_{r}}{\partial r} - \frac{{u}_{θ}^{2}}{r} + \frac{1}{ρ} \frac{\partial p}{\partial r} = 2 {Ω}_{o}^{2} r - 2 {Ω}_{o} {u}_{θ}$$

$${M}_{θ} : \frac{\partial {u}_{θ}}{\partial t} + {u}_{r} \frac{\partial {u}_{θ}}{\partial r} + \frac{{u}_{r} {u}_{θ}}{r} = 2 {Ω}_{o} {u}_{r} ,$$

Consider the steady solution of (20), as given by,

$${u}_{θ} = {Ω}_{o} r + β / r , \qquad ( 17 )$$

$${u}_{r} = α / r ,$$

$$\frac{1}{ρ} \frac{\partial p}{\partial r} = - ( \frac{\partial }{\partial r} ( {u}_{r}^{2} / 2 ) - \frac{{u}_{θ}^{2}}{r} ) .$$

where Ω₀=Ωsin φ is the local latitudinal rotation rate, in the absence of vertical motion.

The first term of u_{θ}is the relevant uniform rotation and (α, β), of units [symbol] ²/t where [symbol] is length and t is time, are source strengths, to bediscussed below.

As an illustration suppose β=0, then streamlines correspond to a source, at the origin, and thecurvature of the streamlines due to the Coriolis acceleration. The stream function, from (17) in dimensionless form, is given by

$$ψ = α θ - \frac{{Ω}_{o} {r}^{2}}{2} . \qquad ( 18 )$$

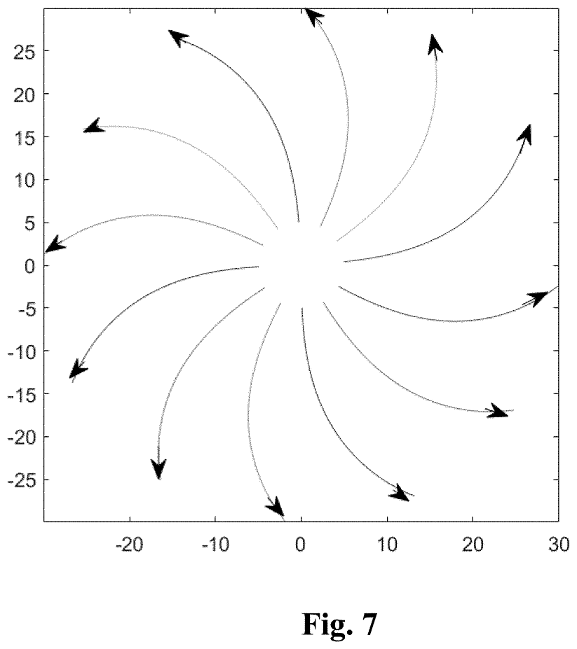

An exemplar of the stream function (20) is shown in FIG. 7.

$$ψ = θ + \frac{{Ω}_{o} {r}^{2}}{2 k} . \qquad ( 19 )$$

Thus, a novel fluid solution has been derived. This solution describes flow in terms of the radial variable, r, measured from the calculated center of the tropical depression, r_{c}=(x_{c},y_{c}). Thus, the flow contains 5 parameters, α, β, r_{c} and a The last is just the local spin of the earth, determined by the latitude. There are parameters are determined by a best fit (in the sense of the least squares) to the actual NOAA data of the tropical depression.

While the extent of a hurricane might be 1000 km, it is fueled by an ocean area of diameter 50 km, a ratio of 1/20, which serves as a general basis of estimate. In general a tropical storm is of limited size, perhaps, less than 200 km, in diameter, more or less. As indicated above, only a circular area less than 20 km, need be cooled by the deeper ocean. This suggests that less than 5 submarines would be more than adequate for the weakening and perhaps squelching of the tropical storm. The submarine pack should induce cyclonic circulation around the above determined center of the tropical storm. Forecasting of the incipient storm by NOAA, could guide the submarine pack over time. Since submarines travel with the speed that is roughly 4 times that of a normal hurricane speed, errors in forecasting are easily remedied. For the application of producing rainfall, similar procedures can be followed, with the exception that the submarine path should induce anti-cyclonic circulation.

A 1^{st} Strategy

FIG. 3. Streamlines for the inviscid model of a tropical depression, based on a circular region around the origin, corresponding to a radius of 30 miles The streamlines correspond to 0=no 0=360°. The streamlines shown above model a tropical depression at a nominal North Atlantic latitude. More southerly latitudes have more radial streamlines, more northerly latitudes the streamlines show more swirl.

For practical application, a NOAA snapshot of a tropical depression is fit to the model, (17). Thus, the data furnishes a and _{ft} as well as the center location , and hence an analytical shape is conferred on the tropical depression.In keeping with the general theme, to inhibit the cyclonic development, the surface layer should be cooled by mixing. Since a tropical depression is small ˜O(10²)km, only a small region, say of diameter 20 km, around the now known center, as suggested below (10), need be mixed, and few submarines are required.

This effect is augmented if the submarine pack executes a circular, cyclonic annular band around the origin, which due to the Coriolis force, allows additional cold water to be lifted to the surface. Additionally, can aerodynamically, steer the atmospheric storm system northward, which is desirable since disturbances north of the 20^{th} latitude rarely develop into cyclones (Knaff et al. 2013; Knaff, Longmore, and Molenar 2014). At more northerly latitudes the surface layer becomes cooler, and a greater Coriolis force pumps deeper water to the surface.

This strategy clearly diminishes moisture accumulation, hence even if the storm is not squelched, less rainfall accompanies the hurricane.

Note that a reversal of the above simple reasoning leads to a method which would enhance hurricane initiation, for the purpose of increasing rainfall.

Further Applications

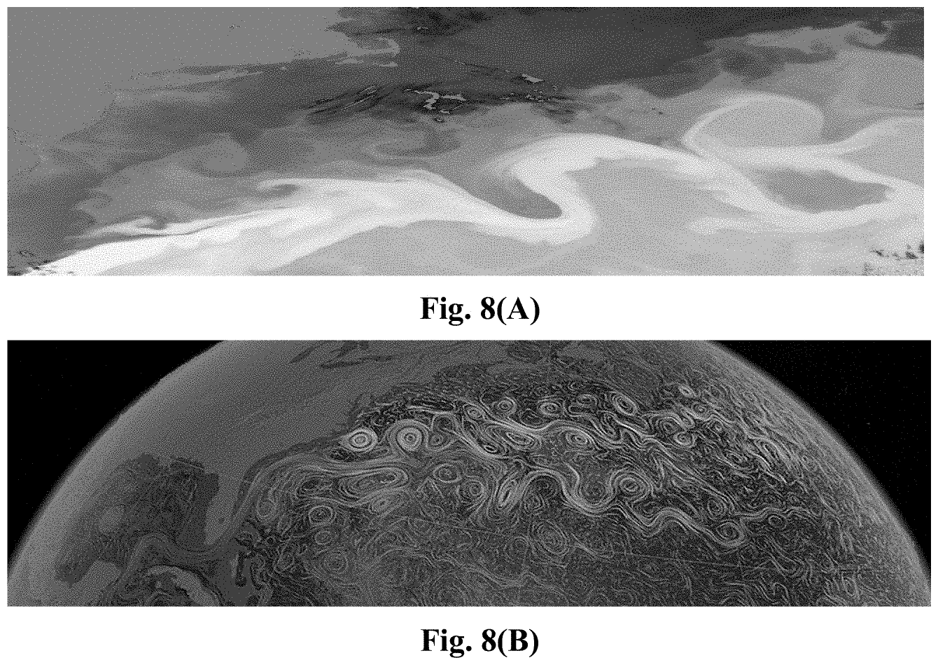

The modeling of other oceanographic phenomena, on the basis of (17) can also be achieved. For example the region known as the eye of a hurricane can be so modeled by choosing a rotating system in which the rotation rate is that of the hurricane eye. Another application would be to mesoscale eddies as shown in FIGS. 8(A) and 8(B), and a choice of rotation based on the data. As for example spawned off of the Gulf Stream (Chelton et al. 2007), that are remotely sensed. Monitored. The data in the cited reference may be used to fit individually measured eddies again by a least squares fitting of (17).

The eddies shown in FIG. 8(A) form unstable loops that pinch off the Gulf Stream. Clearly, these show clockwise preference for a northern loop, that captures cold ocean, and that have counterclockwise preference for a southern loop, that captures warm ocean. The fact that the former are referred to as warm, and cold, respectively, is in agreement with the above description of the model, and adds validity to the contention that (17) models mesoscale eddies.

Also note that “warm” eddies persist for relatively long times, even though the governing equations contain a counterclockwise preference. The persistence of such eddies has been verified by remote-sensing observations. Mesoscale eddies have been linked to hurricane will development (Ma et al. 2017), and might be made to play a role cyclonic initiation and annihilation.

What is claimed is:

1. A method of mitigating the formation of a hurricane comprising the steps of
(a) on detection of a tropical depression, it is analytically mapped in the form (17),with a known center, and resulting in a quick dispatch to the center of a disturbance, of a plurality of vessels modified for mixing stirring of ocean water;
(b) causing said plurality of vessels to undertake a cyclonic flow in an annular band of circulation around the center of the disturbance to cause cooling through mixing and Coriolis lift to diminish hurricane production by virtue of cooling the ocean; and
(c) continuing said activity while following said center of said disturbance until the threat of a hurricane is eliminated.

2. A method as defined in claim 1, further comprising maintaining bases or stations for said plurality of vessels at locations optimally placed with respect to high risk regions where low pressure systems or tropical storms or cyclones frequently form.

3. A method of triggering the formation of a hurricane comprising the steps of
(a) upon detection or the forecast of a tropical depression resulting in predetermined cyclonic activity quickly dispatching, to the center of a disturbance, a plurality of vessels modified for stirring of ocean water;
(b) causing said plurality of vessels to undertake an anti-cyclonic circulatory track about the center of the disturbance that that will draw in the warm surface layer to promote hurricane production; and
(c) continuing said inducement of circulation while following said center of said disturbance until the initiation of the formation of a hurricane is established.

4. A method of promoting the formation of a hurricane comprising the steps of
(a) seeking a rainfall opportunity, viz., a tropical depression which might be steered successfully;
(b) quicky dispatching, to the center of a disturbance, plurality of vessels configured to enhance hurricane production;
(c) continuing the movements of said vessels until hurricane ignition is achieved.
